(19) United States
(12) Patent Application Publication
(10) Pub. No.: US 2010/0179228 A1
(43) Pub. Date: Jul. 15, 2010

(54) Novel Oil-Based Adjuvant Composition

(75) Inventors: Ronald Vermeer, Leverkusen (DE); Manuela Eberhard, Leverkusen (DE); Reiner Fischer, Monheim (DE); Rolf Pontzen, Leichlingen (DE)

Correspondence Address: STERNE, KESSLER, GOLDSTEIN & FOX P.L.L.C., 1100 NEW YORK AVENUE, N.W., WASHINGTON, DC, 20005, US

(73) Assignee: Bayer CropScience AG, Monheim (DE)

(21) Appl. No.: 12/664,284

(22) PCT Filed: May 30, 2008
(86) PCT No.: PCT/EP2008/004292

§ 371 Date: Dec. 11, 2009

(30) Foreign Application Priority Data
Jun. 12, 2007 (EP) 07110022.6

(51) Int. Cl. A01N 25/02; A01N 33/12

(52) U.S. Cl. 514/783

(57) ABSTRACT

The present invention provides compositions comprising oil, surfactants and ammonium salts suspended therein which may be added to agrochemical compositions, improving their activity.

The present invention relates to novel compositions which can be used as adjuvants in the field of crop protection, for example in combination with agrochemically active compounds.

Agrochemically active compounds, in particular those which are applied by the post-emergence method by spraying and which are taken up by the plants via the leaf are frequently applied in combination with tank-mix adjuvants. To this end, the agrochemical formulations are mixed with the tank-mix adjuvants in the spray liquor. These tank-mix adjuvants are added in order to increase the biological activity of the agrochemically active compounds, such as, for example, insecticides, fungicides, bactericides, herbicides, growth regulators, acaricides or nematicides, and/or to improve the applicability of the active compounds.

Here, adjuvants are to be understood as meaning materials which for their part are not biologically active. The biological activity can be improved, for example, by optimizing adherence to the leaf, wetting, distribution or uptake. Some properties of the spray liquor or the spray liquor residue on the treated plant surface which can be optimized are suspendability, emulsifiability, stability, solubility, pH, foaming, surface tension, vapour pressure, compatibility with plants, drift, droplet size or coverage. Adjuvants can be divided into different chemical groups (for example surfactants, fatty acid esters, polymers, oils, buffers, organosilicon compounds, latex suspensions, etc.). The use of adjuvants is of great practical importance and described in detail in the specialist literature (see, for example, C. L. Foy, D. W. Pritchard (Ed.), Pesticide Formulation and Adjuvant Technology, CRC Press, Inc, 1996, Boca Raton, Fla., USA; A. Knowles, Agrow Reports, Adjuvants and additives: 2006 edition, Informa UK Ltd, 2006, United Kingdom; Conference Proceedings ISAA 2004, Cape Town, South Africa).

Numerous adjuvant compositions for use in combination with agrochemically active compounds have already been disclosed.

The use of various oils for improving the effectiveness of pesticides by improving the wetting and distribution properties of the spray residues have been described. Examples of these oils are mineral oils, vegetable oils and esters of these vegetable oils. It is known that vegetable oil esters improve the uptake of many pesticides into the leaf, and that the very low volatility of vegetable oils increases the residual effectiveness of crop protections. Not least, the use of paraffin oil formulations as summer spray treatment and winter spray treatment is known in practice (for example Oleocin® from Bayer CropScience).

U.S. Pat. No. 5,580,567 describes compositions comprising, in addition to oil, an emulsifier system and a buffer. These adjuvants have the advantage that the improvement of the biological activity and the possibility to adjust the pH are combined in one product. U.S. Pat. No. 3,977,322 describes a composition comprising a mineral oil and a vegetable oil which, as a mixture, improve the effectiveness of selective herbicides. A synergistic herbicide composition is described in U.S. Pat. No. 4,755,207. These formulations comprise a plant-compatible oil (purified vegetable oil or highly purified paraffin oil), a surfactant and hydrophobic mycoherbicidal spores.

A further group of adjuvants is that of the ammonium salts. It has already been described in the literature that the activity of various active compounds can be enhanced by adding ammonium salts. However, these are salts which act as detergents (for example WO 95/017817) or salts having relatively long alkyl and/or aryl substituents which act in a permeabilizing manner or increase the solubility of the active compound (for example EP-A 0 453 086, EP-A 0 664 081, FR-A 2 600 494, U.S. Pat. No. 4,844,734, U.S. Pat. No. 5,462,912, U.S. Pat. No. 5,538,937, U.S. Ser. No. 03/0224939, U.S. Ser. No. 05/0009880, U.S. Ser. No. 05/0096386). The prior art furthermore describes the activity only for certain active compounds and/or certain applications of the compositions in question. In yet other cases, they are salts of sulphonic acids where the acids for their part act in a paralyzing manner on the insect (U.S. Pat. No. 2,842,476). An activity increase for example by ammonium sulphate has been described, for example, for the herbicides glyphosate and phosphinothricin (U.S. Pat. No. 6,645,914, EP-A 0 036 106).

The use of ammonium sulphate as formulation auxiliary, too, has been described for certain active compounds and applications (WO 92/16108); however, here it serves to stabilize the formulation, not to enhance the activity.

Furthermore, DE 102 58 856 and WO 06/012209, for example, describe adjuvants comprising various surfactants. Like the ammonium salts, these surfactants are added in order to improve the uptake into the plant.

In many compositions described in the prior art, ammonium is introduced into formulations because the active compounds used are employed as ammonium salts, as is customary in particular for the widely used herbicide glyphosate (for example WO 07/050,090, WO 05/117583, WO 05/013692, WO 06/050141, US 2003/104947, U.S. Pat. No. 5,238,604, DE 197 52 552). However, in the present invention a separate ammonium salt is added.

U.S. Pat. No. 6,423,667 describes oil-based adjuvant compositions which additionally comprise ammonium sulphate and a nonionic surfactant having an HLB value between 10 and 15. In this publication, emphasis is given to the requirement of a low viscosity of the product for optimal dilution in the spray liquor. Accordingly, what is disclosed is a formulation which contains ammonium sulphate as relatively coarse particles, since small particle sizes are described as resulting in a high viscosity. This formulation therefore has the disadvantage that particle sizes (d90) of less than 15 μm, preferably less than 10 μm, which are desired especially for low water application rates per hectare (<200 1/ha) cannot be used. Furthermore, for the user, there are reasons to use ammonium salts other than ammonium sulphate for better biological activity.

WO 00/67573 describes adjuvant compositions for herbicides. However, for these compositions cationic emulsifiers are essential, whereas the compositions of the present invention comprise anionic surfactants.

WO 02/34047 describes a formulation auxiliary for pesticides; however, in this auxiliary an ammonium salt is present as a solution in water, not in particulate form. The compositions of the present invention are anhydrous.

Ready mixes of ammonium salts and penetrants such as oils and/or surfactants in a single product are advantageous for the user, for example with a view to accurate dosing and user safety (no transfer and no mixing required).

The use of ammonium salts in water-based adjuvant compositions has been described in various publications. WO 05/046326 and U.S. Pat. No. 5,356,861 describe compositions which, in addition to water and ammonium sulphate, comprise alkylpolysaccharides. WO 05/046326 claims an improved uptake of nutrients into the fruits of the treated plant. U.S. Pat. No. 5,356,861 discloses the use of a composition for increasing the activity of glyphosate. WO 03/092373 mentions formulations which, in addition to water and ammonium sulphate, comprise an iminodipropionate as amphoteric surfactant. These formulations are to offer a comprehensive solution as tank-mix for herbicides.

The main reason that only few water-based in-can mixtures (i.e. concentrated finish formulations) of ammonium salts with penetrant auxiliaries are known is the poor physical stability of such mixtures. With few exceptions, the penetrants will flocculate owing to the required high salt concentration.

The use of oil as penetrant in combination with ammonium salt, if appropriate as a mixture with further penetrant surfactants, instead of the water/surfactant mixtures described, would be a logical alternative. However, as described, the literature mostly discloses only adjuvant compositions comprising either oil(s) or ammonium salt. One of the difficulties encountered when developing such formulations is the preparation form of the ammonium salt. In aqueous adjuvant compositions, the ammonium salts are present in dissolved form, resulting in a homogeneous liquid formulation. In the various oils suitable for improving the effectiveness of pesticides, the solubility of the suitable ammonium salts is lower than the required amount of the salt. Accordingly, in the oil-based formulations the ammonium salt will be present in crystalline form, resulting in problems during formulation. For example, the customary ammonium salts are, owing to their hardness, difficult to comminute, and after comminution oil-based formulations comprising ammonium salt tend to be of high viscosity. Moreover, in general, ammonium salts in oil-based suspension concentrates are difficult to stabilize.

Accordingly, it was an object to provide novel adjuvant compositions comprising at least one oil suitable for improving the effectiveness of pesticides and a suitable ammonium salt having a narrow particle size distribution in a sufficient amount.

Surprisingly, it has now been found that this object is achieved by the special composition of the present invention.

Accordingly, the present invention relates to an oil-based adjuvant composition comprising
a) at least one oil selected from the group consisting of
   1) vegetable oil
   2) mineral oil
   3) paraffin oil
   4) fatty acid esters and mixtures of various fatty acid esters
b) suspended therein at least one ammonium salt of the formula (I)

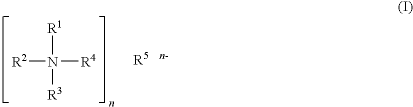

in which
R¹, R², R³ and R⁴ independently of one another represent hydrogen or in each case optionally substituted C₁-C₈-alkyl or mono- or polyunsaturated, optionally substituted C₁-C₈-alkylene, where the substituents may be selected from the group consisting of halogen, nitro and cyano,
n represents 1, 2, 3 or 4,
R⁵ represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate, oxalate, carbonate, pentaborate, sulphite, benzoate, hydrogenoxalate, hydrogencitrate, methylsulphate or tetrafluoroborate,
c) at least one emulsifier
d) at least one nonionic surfactant and at least one anionic surfactant
e) optionally a penetrant and
f) optionally one or more additives from the groups of the antifoams, the preservatives, the antioxidants, the spreading compositions, the colorants and the thickeners.

Here, “oil-based composition” means that the compositions according to the invention are substantially free of water. The water content is preferably less than 1.5% by weight, particularly preferably less than 0.7% by weight. Owing to the low water content, the ammonium salt of the formula (I) is suspended in the compositions according to the invention.

The present invention furthermore relates to a process for preparing these compositions and to their use for improving the activity of crop protection compositions.

Furthermore, it has been found that the oil-based adjuvant composition according to the invention can be prepared by mixing
a) at least one oil selected from the group consisting of
   1) vegetable oil
   2) mineral oil
   3) paraffin oil
   4) fatty acid esters and mixtures of various fatty acid esters
b) at least one ammonium salt of the formula (I)
c) at least one emulsifier
d) at least one nonionic surfactant and at least one anionic surfactant
e) optionally a penetrant and
f) optionally one or more additives from the groups of the antifoams, the preservatives, the antioxidants, the spreading compositions, the colorants and the thickeners
   and then, if required, grinding the suspension formed.

Finally, it has been found that the oil-based adjuvant compositions according to the invention in combination with formulations comprising agrochemically active compounds are highly suitable for application to plants and/or their habitat.

It is extremely surprising that the oil-based adjuvant compositions according to the invention have low viscosity and very good stability and in particular that even after storage at changing temperatures no significant crystal growth of the ammonium salt was observed. It is also unexpected that they have considerably better biological efficacy than the abovementioned adjuvant compositions of the most similar compositions. Besides, with respect to their activity, the oil-based adjuvant compositions according to the invention surprisingly also surpass analogous preparations which, in addition to the other components, comprise either only ammonium salt or only oil. Based on the prior art described above, such a synergistic effect was unforeseeable.

The oil-based adjuvant compositions according to the invention have a number of further advantages. Thus, the number of tank-mix applications required is reduced since a plurality of the properties to be optimized have been combined in the adjuvant compositions according to the invention. For this reason, the user has to mix his pesticides with only one instead of a plurality of mixing partners in the spray liquor. An advantage of this is that, when agrochemical compositions are used, dosage errors are avoided and the safety of the users is improved. Also avoided is the use of packaging material for a plurality of tank-mix products. Another advantage is that, when diluting the adjuvant composition according to the invention with water, the pH of the spray liquor can be controlled by the selection of the ammonium salt in the product. Finally, the oil-based adjuvant compositions according to the invention have a favourable effect on the biological efficacy of the active components of the formulations to which the adjuvant compositions are added, so that, compared to customary preparations, either a higher efficacy is achieved or less pesticide is required.

Preferred embodiments of the subject of the invention are described below.

The vegetable oils present in the adjuvant compositions according to the invention are generally known and commercially available. The term vegetable oils is to be understood as including, for example, oils from oleagineous plant species, such as soya bean oil, rapeseed oil, maize germ oil, maize kernel oil, sunflower oil, cottonseed oil, linseed oil, coconut oil, palm oil, thistle oil, walnut oil, arachis oil, olive oil or castor oil, colza oil, in particular soya bean oil, rapeseed oil, maize germ oil or sunflower oil and mixtures thereof. The vegetable oils (triglycerides) are preferably esters of C₁₀-C₂₂-, preferably C₁₂-C₂₀-, fatty acids of glycerol. The C₁₀-C₂₂-fatty acid esters of glycerol are, for example, esters of unsaturated or saturated C₁₂-C₂₀-fatty acids, in particular those having an even number of carbon atoms, for example erucic acid, lauric acid, palmitic acid, and in particular C₁₈-fatty acids, such as stearic acid, oleic acid, linoleic acid or linolenic acid.

Suitable mineral oils are various commercially available distillate fractions of mineral oil (petroleum). Preference is given to mixtures of open-chain C₁₄-C₃₀-hydrocarbons, cyclic hydrocarbons (naphthenes) and aromatic hydrocarbons. The hydrocarbons can be either straight-chain or branched. Particular preference is given to mixtures having an aromatic portion of less than 8% by weight. Very particular preference is given to mixtures having an aromatic portion of less than 4% by weight.

Suitable paraffin oils are straight-chain and branched C₁₄-C₃₀-hydrocarbons. Paraffin oils are also known as base oil or white oil and are commercially available, for example, as Bayol® 85 (Exxon Mobil, Machelen, Belgium), Marcol® 82 (Exxon Mobil, Machelen, Belgium), BAR 0020 (RA.M.oil S.p.A., Naples, Italy), Pionier 0032-20 (Hansen & Rosenthal KG, Hamburg, Germany) or, for example, Kristol M14 (Carless, Surrey, England).

Suitable fatty acid esters are alkyl fatty acid esters, such as C₁-C₂₀-alkyl C₁₀-C₂₂-fatty acid esters. Preference is given to methyl esters, ethyl esters, propyl esters, butyl esters, 2-ethylhexyl esters and dodecyl esters. Particular preference is given to methyl esters and ethyl esters. Examples of synthetic fatty acid esters are, for example, those which are derived from fatty acids having an odd number of carbon atoms, such as C₁₁-C₂₁-fatty acid esters. The transesterification can be carried out by known methods, as described, for example, in Römpp Chemie Lexikon, 9th Edition, Volume 2, page 1343, Thieme Verlag, Stuttgart.

In the adjuvant compositions according to the invention, the fatty acid esters can be present in the form of commercially available esters, in particular esters such as rapeseed oil methyl ester, for example Edenor® MESU (Cognis, Germany) or the Agnique® ME series (Cognis, Germany) or in the form of commercially available oil-containing formulation additives, in particular those based on rapeseed oil methyl ester or rapeseed oil ethyl ester, for example Hasten® (Victoria Chemicals, Australia), Actirob® B (Novance, France) or Stefes Mero® (Stefes, Germany).

Ammonium salts according to the invention are defined by formula (I)

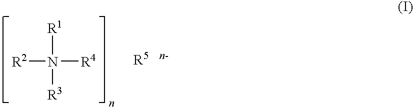

in which
R¹, R², R³ and R⁴ independently of one another represent hydrogen or in each case optionally substituted C₁-C_{g}-alkyl or mono- or polyunsaturated, optionally substituted C₁-C₈-alkylene, where the substituents may be selected from the group consisting of halogen, nitro and cyano,
R¹, R², R³ and R⁴ preferably independently of one another represent hydrogen or in each case optionally substituted C₁-C₄-alkyl, where the substituents may be selected from the group consisting of halogen, nitro and cyano,
R¹, R², R³ and R⁴ particularly preferably independently of one another represent hydrogen, methyl, ethyl, n-propyl, isopropyl, n-butyl, isobutyl, s-butyl or t-butyl,
R¹, R², R³ and R⁴ very particularly preferably represent hydrogen,
R¹, R², R³ and R⁴ furthermore very particularly preferably all represent methyl or all represent ethyl,
n represents 1, 2, 3 or 4,
n preferably represents 1 or 2,
R⁵ represents bicarbonate, tetraborate, fluoride, bromide, iodide, chloride, monohydrogen-phosphate, dihydrogenphosphate, hydrogensulphate, tartrate, sulphate, nitrate, thiosulphate, thiocyanate, formate, lactate, acetate, propionate, butyrate, pentanoate, citrate, oxalate, carbonate, pentaborate, sulphite, benzoate, hydrogenoxalate, hydrogencitrate, methyl-sulphate or tetrafluoroborate,
R⁵ preferably represents lactate, sulphate, nitrate, thiosulphate, thiocyanate, citrate, oxalate, formate, monohydrogenphosphate or dihydrogenphosphate,
R⁵ particularly preferably represents sulphate, monohydrogenphosphate or dihydrogen-phosphate.

Preferred salts are ammonium bicarbonate, ammonium tetraborate, ammonium fluoride, ammonium bromide, ammonium iodide, ammonium chloride, diammonium monohydrogen-phosphate, ammonium dihydrogenphosphate, ammonium hydrogensulphate, ammonium tartrate, ammonium sulphate, ammonium nitrate, ammonium thiosulphate, ammonium thiocyanate, ammonium formate, ammonium lactate, ammonium acetate, ammonium propionate, ammonium butyrate, ammonium pentanoate, ammonium citrate, ammonium oxalate, ammonium carbonate, ammonium pentaborate, ammonium sulphite, ammonium benzoate, ammonium hydrogenoxalate, ammonium hydrogencitrate, ammonium methylsulphate and ammonium tetrafluoroborate.

Particularly preferred salts are diammonium monohydrogenphosphate, ammonium dihydrogen-phosphate, ammonium sulphate, ammonium nitrate, ammonium thiosulphate, ammonium thiocyanate, ammonium formate, ammonium lactate, ammonium citrate and ammonium oxalate.

Particularly preferred salts are diammonium monohydrogenphosphate, ammonium dihydrogen-phosphate and ammonium sulphate.

Emulsifiers which may be used are, for example, ethoxylated nonylphenols, reaction products of alkylphenols with ethylene oxide and/or propylene oxide, ethoxylated arylalkylphenols, furthermore ethoxylated and propoxylated arylalkylphenols, and also sulphated or phosphated arylalkyl ethoxylates and/or arylalkyl ethoxypropoxylates, where sorbitan derivatives, such as polyethylene oxide sorbitan fatty acid esters and sorbitan fatty acid esters may be mentioned by way of example.

Suitable nonionic surfactants are all substances of this type which can usually be employed in agrochemical compositions. Polyethylene oxide/polypropylene oxide block copolymers, polyethylene glycol ethers of straight-chain alcohols, reaction products of fatty acids with ethylene oxide and/or propylene oxide may be mentioned as being preferred, furthermore polyvinyl alcohol, polyvinyl pyrrolidone, mixed polymers of polyvinyl alcohol and polyvinyl pyrrolidone and also copolymers of (meth)acrylic acid and (meth)acrylic acid esters, furthermore alkyl ethoxylates and alkylaryl ethoxylates which may optionally be phosphated and optionally be neutralized with bases, an example being sorbitol ethoxylates.

Suitable anionic surfactants are all substances of this type which can usually be used in agrochemical compositions. Preference is give to alkali metal and alkaline earth metal salts of alkylsulphonic acids or alkylarylsulphonic acids.

A further preferred group of anionic surfactants or dispersants are the following salts that have poor solubility in vegetable oil: salts of polystyrenesulphonic acids, salts of polyvinylsulphonic acids, salts of naphthalenesulphonic acid/formaldehyde condensation products, salts of condensation products of naphthalenesulphonic acid, phenolsulphonic acid and formaldehyde and also salts of lignosulphonic acid.

Suitable penetrants in the present context include all those substances which are typically used to enhance the penetration of agrochemically active compounds into plants. Penetrants are defined in this context by their ability to penetrate from the aqueous spray liquor and/or from the spray coating into the cuticles of the plants and thereby to increase the mobility of active compounds in the cuticles. The method described in the literature (Baur et al., 1997, Pesticide Science 51, 131-152) and below can be used to determine this property.

Suitable penetrants are, for example, alkanol alkoxylates. Penetrants according to the invention are alkanol alkoxylates of the formula

R—O-(-AO)ₘ—R′ (II)

in which
R represents straight-chain or branched alkyl having 4 to 20 carbon atoms,
R′ represents hydrogen, methyl, ethyl, n-propyl, isopropyl, n-butyl, isobutyl, t-butyl, n-pentyl or n-hexyl,
AO represents an ethylene oxide radical, a propylene oxide radical, a butylene oxide radical or represents mixtures of ethylene oxide and propylene oxide radicals or butylene oxide radicals and
m represents numbers from 2 to 30.

A preferred group of penetrants are alkanol alkoxylates of the formula

R—O-(-EO—)_{b}—R′ (II-a)

in which
R is as defined above,
R′ is as defined above,
EO represents —CH₂—CH₂—O— and
B represents numbers from 2 to 20.

A further preferred group of penetrants are alkanol alkoxylates of the formula

R—O-(-EO—)ₚ—(—PO—)_{q}—R′ (II-b)

in which
R is as defined above,
R′ is as defined above,
EO represents CH₂—CH₂—O—,
PO represents

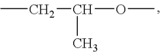

P represents numbers from 1 to 10 and
q represents numbers from 1 to 10.

A further preferred group of penetrants are alkanol alkoxylates of the formula

R—O—(—PO—)ᵣ-(EO—)ₛ—R′ (II-c)

in which
R is as defined above,
R′ is as defined above,
EO represents —CH₂—CH₂—O—,
PO represents

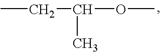

r represents numbers from 1 to 10 and
s represents numbers from 1 to 10.

A further preferred group of penetrants are alkanol alkoxylates of the formula

R—O-(-EO—)ᵥ—(—BO—)_{X}—R′ (II-d)

in which
R and R′ are as defined above,
EO represents CH₂—CH₂—O—,
BO represents

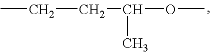

v represents numbers from 1 to 10 and
x represents numbers from 1 to 10.

A further preferred group of penetrants are alkanol alkoxylates of the formula

R—O—(—BO-)_{y}-(-EO—)_{z}—R′ (II-e)

in which
R and R′ are as defined above,
BO represents

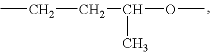

EO represents CH₂—CH₂—O—,
y represents numbers from 1 to 10 and
z represents numbers from 1 to 10.

A further preferred group of penetrants are alkanol alkoxylates of the formula

CH₃—(CH₂)ₜ—CH₂—O—(—CH₂—CH₂—O—)ᵤ—R′ (II-f)

in which
R′ is as defined above,
t represents numbers from 8 to 13 and
u represents numbers from 6 to 17.

In the formulae given above,
R preferably represents butyl, isobutyl, n-pentyl, isopentyl, neopentyl, n-hexyl, isohexyl, n-octyl, isooctyl, 2-ethylhexyl, nonyl, isononyl, decyl, n-dodecyl, isododecyl, lauryl, myristyl, isotridecyl, trimethylnonyl, palmityl, stearyl or eicosyl.

Examples which may be mentioned of particularly preferred alkanol alkoxylates of the formula (II-a) are ethoxylated Guerbet alcohols of the formula (II-a-1):

R—O-(-EO—)_{b}—R′ (II-a-1)

in which
R represents a C₁₆-C₁₈-Guerbet alcohol,
R′ represents n-butyl, isobutyl or t-butyl,
EO represents —CH₂—CH₂—O— and
b represents numbers from 4 to 10.

An example which may be mentioned of a particularly preferred alkanol alkoxylate of the formula (II-c) is 2-ethylhexyl alkoxylate of the formula

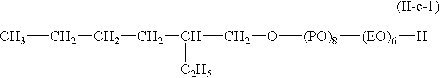

in which
EO represents —CH₂—CH₂—O—,
PO represents

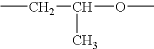

and
the numbers 8 and 6 are average values.

An example which may be mentioned of a particularly preferred alkanol alkoxylate of the formula (II-d) is the formula

CH₃—(CH₂)₁₀—O-(-EO—)₆—(—BO—)₂—CH₃ (II-d-1)

in which
EO represents CH₂—CH₂—O—,
BO represents

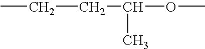

and
the numbers 10, 6 and 2 are average values.

Particularly preferred alkanol alkoxylates of the formula (II-f) are compounds of this formula in which
t represents numbers from 9 to 12 and
u represents numbers from 7 to 9.

The alkanol alkoxylate of the formula (II-f-1)

CH₃—(CH₂)ₜ—CH₂—O—(—CH₂—CH₂—O—)ᵤ—H (II-f-1)

in which
t represents the average value 10.5 and
u represents the average value 8.4
may be mentioned as being very particularly preferred.

The above formulae provide a general definition of the alkanol alkoxylates. These substances are mixtures of substances of the stated type with different chain length. The indices therefore have average values which may also deviate from whole numbers.

The alkanol alkoxylates of the formulae given are known and in some cases are available commercially or can be prepared by known methods (cf. WO 98-35 553, WO 00-35 278 and EP-A 0 681 865).

Suitable antifoams include all substances that can normally be used for this purpose in agrochemical compositions. Preference is given to silicone oils and magnesium stearate.

Suitable preservatives include all substances that can normally be used for this purpose in agrochemical compositions of this type. Examples that may be mentioned include Preventol® (from Bayer AG) and Proxel®.

Suitable antioxidants include all substances that can normally be used for this purpose in agrochemical compositions. Preference is given to 2,6-di-tert-butyl-4-methylphenol.

Suitable spreading compositions include all substances that can normally be used for this purpose in agrochemical compositions. Preference is given to alkylsiloxanes.

Suitable colorants include all substances that can normally be used for this purpose in agrochemical compositions. Mention may be made, by way of example, of titanium dioxide, pigmentary carbon black, zinc oxide and blue pigments, and also Permanent Red FGR.

Suitable thickeners include all substances that can normally be used for this purpose in agrochemical compositions and which act as thickeners. Preference is given to inorganic particles, such as carbonates, silicates and oxides, and also organic substances, such as urea/formaldehyde condensates. By way of example, mention may be made of kaolin, rutile, silicon dioxide, finely divided silica, silica gels, and also natural and synthetic silicates, such as bentonite, attapulgite or montmorillonite, and additionally talc.

Preferably, the present invention relates to an oil-based adjuvant composition comprising
a) at least one oil selected from the group consisting of fatty acid esters and mixtures of various fatty acid esters
b) suspended therein at least one ammonium salt selected from the group consisting of ammonium sulphate and ammonium dihydrogensulphate
c) at least one emulsifier
d) at least one nonionic surfactant and at least one anionic surfactant
e) a penetrant and
f) if appropriate one or more additives from the groups of the antifoams, the preservatives, the antioxidants, the spreading compositions, the colorants and the thickeners.

The content of the individual components in the compositions according to the invention may be varied within a relatively wide range. Preference is given to compositions comprising
a) 20-75% by weight of oil
b) 5-35% by weight of the ammonium salt of the formula (I)
c) 1-15% by weight of emulsifier
d) 1-15% by weight of nonionic surfactant and/or anionic surfactant
e) 0-25% by weight of penetrant
f) 0-10% by weight of one or more additives from the groups of the antifoams, the preservatives, the antioxidants, the spreading compositions, the colorants and the thickeners.

Particular preference is given to compositions comprising
a) 40-60% by weight of oil
b) 10-30% by weight of the ammonium salt of the formula (I)
c) 5-12% by weight of emulsifier
d) 5-10% by weight of nonionic surfactant and/or anionic surfactant
e) 0-20% by weight of penetrant
f) 0-7.5% by weight of one or more additives from the groups of the antifoams, the preservatives, the antioxidants, the spreading compositions, the colorants and the thickeners.

The preparation of the oil-based adjuvant compositions according to the invention is carried out by mixing the components in the particular ratios desired with one another. The order in which the components are mixed with one another is immaterial. Expediently, the solid components are employed in a finely ground state. However, it is also possible to subject the suspension formed after the mixing of the components initially to a coarse grinding and then to a fine grinding so that the mean particle size is less than 20 μm. Preference is given to suspension concentrates in which the solid particles have a mean particle size between 1 and 10 μm.

When carrying out the process according to the invention, the temperatures can be varied within a certain range. In general, the process is carried out at temperatures between 10° C. and 60° C., preferably between 15° C. and 40° C.

Suitable for carrying out the process according to the invention are customary mixers and grinders used for preparing agrochemical formulations.

The oil-based adjuvant compositions according to the invention are formulations which remain stable even after relatively long storage at elevated temperatures or in the cold, since no crystal growth is observed. By dilution with water, they can be converted into homogeneous spray liquors.

The adjuvant compositions according to the invention can be used in combination with various pesticide formulations. Preference is given to pesticide formulations comprising one or more active compounds from the group of the insecticides, fungicides, bactericides, herbicides, growth regulators, acaricides or nematicides. In addition, they may be applied in combination with fertilizer and/or further nutrients. The optimum effect of the application may be influenced by the nature of the treated plant, by the disease, by the spray apparatus, by the spray volume, by the pressure, by the droplet size, by the mixing partners, by environmental factors and other factors. Accordingly, it is important to monitor the spray coating formed by the treatment and—if required—to adjust the use concentration of the adjuvant composition.

In the application, the weight ratio of agrochemically active compound to adjuvant composition according to the invention is generally in the range of from 1:10 000 to 100:1, in particular from 1:1000 to 10:1, depending on the activity of the agrochemically active compound in question. In the application, the concentration of agrochemically active compound is generally from 10⁻⁶ to 10% by weight, preferably from 10⁻⁵ to 4% by weight, in the composition applied, for example the spray liquor, at an application rate of from 1 to 5000 1/ha, preferably from 50 to 1000 1/ha. The concentration of the adjuvant composition according to the invention is generally from 0.005 to 5% by weight, preferably from 0.05 to 3% by weight, in the composition applied, for example the spray liquor, at an application rate from 1 to 5000 1/ha, preferably from 50 to 1000 1/ha.

To use the adjuvant composition according to the invention with an agrochemical formulation, half of the spray tank is filled with water and stirred. In the next step, the various products are added, in the following order: initially, the solid formulations are stirred in, then the suspension concentrates and the adjuvant composition according to the invention and finally the homogeneous liquid formulations. The spray tank is filled with water and homogenized again. When using formulations sensitive to high salt concentrations, it is also possible to add the adjuvant composition according to the invention to the spray liquor last.

With the aid of the oil-based adjuvant composition according to the invention, it is possible to apply agrochemically active compounds in a particularly advantageous manner to plants and/or their habitat. Plants are to be understood as meaning in the present context all plants and plant populations such as wanted and unwanted wild plants or crop plants (including naturally occurring crop plants). Crop plants can be plants which can be obtained by conventional plant breeding and optimization methods or by biotechnological and genetic engineering methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits and seeds, and also roots, tubers and rhizomes. The plant parts also include harvested material, and also vegetative and generative propagation material, for example cuttings, tubers, rhizomes, offshoots and seeds. Here, the agrochemically active compounds contained exhibit better biological efficacy than in the application in the form of the corresponding conventional formulations.

The invention is illustrated by the examples below.

### PREPARATION EXAMPLES

### Example 1

To Produce a Suspension Concentrate of the Adjuvant Composition,

250 g of ammonium sulphate
44 g of emulsifier SO 70
66 g of emulsifier 1371 A

### 90 g of Agrimer® AL 22

### 10 g of Morwet® D-425

4 g of polydimethylsiloxane

### 8 g of Vulkanox® BHT

### 540 g of Edenor® ME SU

are added at room temperature with stirring. After the addition is ended, stirring at room temperature is continued for 10 minutes. The homogeneous suspension formed in this manner is subjected initially to coarse grinding and then to fine grinding, so that a suspension is obtained in which 90% of the solid particles have a particle size of less than 6 μm.

The following compositions were prepared analogously to Example 1:

TABLE 1

| | 2 | 3 | 4 | 5 | 6 | 7 | 8 | 9 | 10 | 11 | 12 | 13 |
|---|---|---|---|---|---|---|---|---|---|---|---|---|
| Ammonium sulphate | 250 | 250 | 250 | 250 | 250 | 250 | 250 | 250 | | | | |
| Ammonium | | | | | | | | | 100 | 150 | 150 | 250 |
| dihydrogenphosphate | | | | | | | | | | | | |
| Diammonium | | | | | | | | | | | | |
| hydrogenphosphate | | | | | | | | | | | | |
| Edenor ® ME SU | | | | | 535 | 585 | 570 | 589 | | 639 | 619 | 539 |
| Sunflower oil | 395 | 395 | 375 | | | | | | | | | |
| Rapeseed oil | | | | 395 | | | | | | | | |
| Bayol ® 95 | | | | | | | | | | | | |
| Exxsol ® D 140 | | | | | | | | | 599 | | | |
| Emulsifier SO 70 | | | | | 44 | 44 | 44 | 44 | | 44 | 44 | 44 |
| Emulsifier 1371 A | | | | | 66 | 66 | 66 | 66 | | 66 | 66 | 66 |
| Atplus 309 F | | | | | | | | | | | | |
| Arlatone ® T(V) | 100 | 100 | 100 | 100 | | | | | | | | |
| Agrimer ® AL 22 | | 45 | | 45 | 90 | | | | 20 | | | |
| Morwet ® D-425 | 5 | 5 | 5 | 5 | 10 | | | | 10 | 10 | 10 | 10 |
| Atlox ® 4914 | | | | | | 50 | 50 | 50 | | | | |
| Atlox ® 4851B | | | | | | | | | | | | |
| Berol ® 9968 | | | | | | | | | | | | |
| Rhodafac ® MB | | | | | | | | | 70 | | | |
| Rhodafac ® RS 610 | 45 | | 45 | | | | | | | 90 | 90 | 90 |
| Rhodafac ® RS 410 | | | | | | | | | | | | |
| Zephrym ® PD 7000 | | | | | | | | | | | | |
| Dehypon ® G 2084 | | | | | | | | | 200 | | | |
| Agnique ® KE 3551 | 200 | 200 | 200 | 200 | | | | | | | | |
| Silfoam ® 1132 | 1 | 1 | 1 | 1 | 1 | 1 | 1 | 1 | 1 | 1 | 1 | 1 |
| Vulkanox ® BHT | 2 | 2 | 2 | 2 | 2 | 2 | 2 | | | | | |
| Citric acid | 2 | 2 | 2 | 2 | 2 | 2 | 2 | | | | | |
| Aerosil ® R 812 S | | | 20 | | | | 15 | | | | 20 | |

| | 14 | 15 | 16 | 17 | 18 | 19 | 20 |
|---|---|---|---|---|---|---|---|
| Ammonium sulphate | 250 | | 250 | 250 | 250 | 250 | |
| Ammonium | | | | | | | |
| dihydrogenphosphate | | | | | | | |
| Diammonium | | 250 | | | | | 250 |
| hydrogenphosphate | | | | | | | |
| Edenor ® ME SU | 539 | 539 | | | | | 594 |
| Sunflower oil | | | | | | | |
| Rapeseed oil | | | | | | | |
| Bayol ® 95 | | | 404 | 399 | 399 | 399 | |
| Exxsol ® D 140 | | | | | | | |
| Emulsifier SO 70 | 44 | 44 | | | | | 46 |
| Emulsifier 1371 A | 66 | 66 | | | | | 54 |
| Atplus 309 F | | | 100 | 100 | 100 | 100 | |
| Arlatone ® T(V) | | | | | | | |
| Agrimer ® AL 22 | | | | | | | |
| Morwet ® D-425 | 10 | 10 | | 5 | 5 | 5 | 5 |
| Atlox ® 4914 | | | | | | | |
| Atlox ® 4851B | | | 45 | | | | |
| Berol ® 9968 | | | | | | 45 | |
| Rhodafac ® MB | | | | | | | 50 |
| Rhodafac ® RS 610 | 90 | 90 | | | | | |
| Rhodafac ® RS 410 | | | | | 45 | | |
| Zephrym ® PD 7000 | | | | 45 | | | |
| Dehypon ® G 2084 | | | 200 | 200 | 200 | 200 | |
| Agnique ® KE 3551 | | | | | | | |
| Silfoam ® 1132 | 1 | 1 | 1 | 1 | 1 | 1 | 1 |
| Vulkanox ® BHT | | | | | | | |
| Citric acid | | | | | | | |
| Aerosil ® R 812 S | | | | | | | |

The components, defined by their trade names, of the compositions according to the invention are available at the following suppliers:

TABLE 2

| Trade name | Compound type | Supplier |
|---|---|---|
| Aerosil ® R 812 S | Hydrophobic silica | Degussa |
| Agnique ® KE 3552 | Alkanol alkoxylate | Cognis |
| Agrimer ® AL 22 | Polyvinylpyrrolidone derivative | ISP |
| Arlatone ® T | PEG-40 sorbitan peroleate, nonionic | Uniqema |
| Atlox ® 4851 B | POE triglyceride alkylaryl/sulphonate mixture | Uniqema |
| Atlox ® 4914 | Polymeric surfactant | Uniqema |
| Atplus ® 309 F | Anionic/nonionic mixture | Uniqema |
| Bayol ® 95 | Paraffin oil | Exxonmobil |
| Berol ® 9968 | Ca DBS nonionic blend | AkzoNobel |
| Dehypon ® G 2084 | Guerbet alcohol polyglycol ether butyl | Cognis |
| Edenor ® ME SU | Rapeseed oil methyl ester | Cognis |
| Emulsifier ® 1371 A | Alkylarylsulphonate | Lanxess |
| Emulsifier ® SO 70 | Fatty acid polyethylene ether ester | Lanxess |
| Exxsol ® D 140 | Mineral oil | Exxonmobil |
| Morwet ® D 425 | Naphthalenesulphonate | Witco |
| Rhodafac ® MB | Tridecylpolyoxyethylene ester phosphate | Rhodia |
| Rhodafac ® RS 410 | Tridecylpolyoxyethylene ester phosphate | Rhodia |
| Rhodafac ® RS 610 | Tridecylpolyoxyethylene ester phosphate | Rhodia |
| Silfoam ® 1132 | Polydimethylsiloxane | Wacker Chemie |
| Vulkanox ® BHT | Butylated hydroxytoluene | Lanxess |
| Zephrym ® PD 7000 | Polyoxyalkyleneamine derivative | Uniqema |

### Use Examples

### Example I

### Stability Test

To determine the stability, in each case 100 g of a suspension concentrate of the compositions described in Examples 7 and 20 are stored for several weeks at
room temperature (RT),
   +54° C.
      changing temperatures (TW: 6 hours at −15° C., then 6 hours at +30° C.).

The test results are compiled in the tables below.

TABLE 3
Physical data directly after the preparation (OTW) of the formulation

| | OTW (7) | OTW (20) |
|---|---|---|
| Sediment volume in %*⁾ | 100 | 100 |
| Particle size**⁾ in μm | 4.6 | 3.9 |
| Viscosity ***) in mPa · s | 500 | 230 |

*⁾Sediment volume = volume of the sediment phase compared to the total volume of the sample.
**⁾What was measured was the particle size d₉₀ of the oil phase saturated with active compound which was not exceeded by 90% of the solid particles in the oil phase.
***) What was measured was the viscosity at a shear rate of 7.5 (1/s) using a rheometer of the type DSR 301 from Anton Paar.

TABLE 4
Physical data of compositions according to the invention after two
weeks of storage at various temperatures

| | After 2 weeks at | | | |
|---|---|---|---|---|
| | TW (7) | 54° C. (7) | TW (20) | 54° C. (20) |
| Sediment volume in %*⁾ | 80 | 92 | 70 | 72 |
| Sediment | none | none | none | none |
| Redispersibility | good | good | good | good |
| Particle size**⁾ in μm | 6.6 | 5.6 | 4.7 | 4.5 |
| Viscosity | 418 | 551 | 200 | 297 |

*⁾Sediment volume = volume of the sediment phase compared to the total volume of the sample.
**⁾What was measured was the particle size d₉₀ of the oil phase saturated with active compound which was not exceeded by 90% of the solid particles in the oil phase.
***⁾What was measured was the viscosity at a shear rate of 7.5 (1/s) using a rheometer of the type DSR 301 from Anton Paar.

TABLE 5
Physical data of compositions according to the invention after eight
weeks of storage at various temperatures

| | After 8 weeks at | | | | | |
|---|---|---|---|---|---|---|
| | Example 7 | | | Example 20 | | |
| | RT | 54° C. | TW | RT | 54° C. | TW |
| Sediment volume in %*⁾ | 80 | 73 | 70 | 70 | 65 | 55 |
| Sediment | none | none | none | none | none | none |
| Redispersibility | good | good | good | good | good | good |
| Particle size**⁾ in μm | 6.1 | 6.1 | 5.6 | 5.7 | 4.6 | 5.6 |
| Viscosity | 617 | 795 | 627 | 194 | 283 | 207 |

*⁾Sediment volume = volume of the sediment phase compared to the total volume of the sample.
**⁾What was measured was the particle size d₉₀ of the oil phase saturated with active compound which was not exceeded by 90% of the solid particles in the oil phase.
***⁾What was measured was the viscosity at a shear rate of 7.5 (1/s) using a rheometer of the type DSR 301 from Anton Paar.

### Example II

### Penetration Test

This test measures the penetration of active compounds through enzymatically isolated cuticles of apple leaves.

Leaves used are cut in the fully developed state from apple trees of the Golden Delicious variety.

The cuticles are isolated as follows:
first of all, leaf discs labelled on the underside with dye and formed by punching were filled by means of vacuum infiltration with a pectinase solution (0.2% to 2% strength) buffered to a pH of between 3 and 4,
then sodium azide was added and
the leaf discs thus treated were left to stand until the original leaf structure broke down and the non-cellular cuticles underwent detachment.

Thereafter only those cuticles from the top leaf sides that were free from stomata and hairs were used. They were washed a number of times in alternation with water and with a buffer solution, pH 7. The clean cuticles obtained were, finally, applied to Teflon plaques, smoothed with a gentle jet of air, and dried.

In the next step, the cuticular membranes obtained in this way were placed in stainless steel diffusion cells (=transport chambers) for the purpose of membrane transport investigations. For these investigations the cuticles were placed centrally using tweezers on the edges of the diffusion cells, which were coated with silicone grease, and sealed with a ring, which was likewise greased. The arrangement is chosen so that the morphological outer face of the cuticles is directed outwards, in other words to the air, while the original inner face is facing the interior of the diffusion cell. The diffusion cells were filled with water or with a mixture of water and solvent.

To determine the penetration, in each case 9 μl of a spray liquor of the compositions mentioned below were applied to the outer face of a cuticle.

All spray liquors were prepared from a Tembotrione WP 20 formulation of the composition below:

| | |
|---|---|
| Tembotrione | 20% by weight |
| Texapon ® K12 | 30% by weight |
| Sipernat ® 22 S | 20% by weight |
| Sispersant ® SS | 10% by weight |
| Calgon ® T | 5% by weight |
| Fluowet ® PP | 0.2% by weight |
| Kaolin ® | remainder |

### Spray Liquor A (Comparison)

| | |
|---|---|
| 1 g/l | of rapeseed oil methyl ester |
| 0.5 g/l | of Tembotrione WP 20 |

Rapeseed oil methyl ester was used as RME EW 500 (50% rapeseed oil methyl ester, 0.5% Pluronic® PE 10500 (BASF), remainder water).

### Spray Liquor B (Comparison)

| | |
|---|---|
| 1 g/l | of ammonium sulphate |
| 0.5 g/l | of Tembotrione WP 20 |

### Spray Liquor C (Comparison)

| | |
|---|---|
| 1 g/l | of rapeseed oil methyl ester |
| 1 g/l | of ammonium sulphate |
| 0.5 g/l | of Tembotrione WP 20 |

Rapeseed oil methyl ester was used as RME EW 500 (50% rapeseed oil methyl ester, 0.5% Pluronic® PE 10500 (BASF), remainder water).

### Spray Liquor D (According to the Invention)

| | |
|---|---|
| 1 g/l | of adjuvant composition according to the invention |
| | according to Example 7 |
| 0.5 g/l | of Tembotrione WP 20 |

### Spray Liquor E (According to the Invention)

| | |
|---|---|
| 2 g/l | of adjuvant composition according to the invention |
| | according to Example 7 |
| 0.5 g/l | of Tembotrione WP 20 |

### Spray Liquor F (According to the Invention)

| | |
|---|---|
| 3 g/l | of adjuvant composition according to the invention |
| | according to Example 7 |
| 0.5 g/l | of Tembotrione WP 20 |

TABLE 6

| | | | | Examples | | |
|---|---|---|---|---|---|---|
| | Comparative | | | according to | | |
| | examples | | | the invention | | |
| | A | B | C | D | E | F |
| RME | 0.5 | | 0.5 | 0.59 | 1.18 | 1.77 |
| AMS | | 1 | 1 | 0.25 | 0.5 | 0.75 |
| Active | 0.5 | 0.5 | 0.5 | 0.5 | 0.5 | 0.5 |
| compound | | | | | | |

### CIPAC C Water was Used in Each of the Spray Liquors.

After the spray liquors had been applied the water was evaporated in each case and then the chambers were inverted and placed into thermostatted troughs, where in each case the outside of the cuticles was exposed to a saturated aqueous calcium nitrate 4-hydrate solution. Accordingly, the penetration which began took place at a relative atmospheric humidity of 56% and a set temperature of 25° C. At regular intervals, samples were taken using a syringe and the amount of penetrated active compound was measured using HPLC.

The test results are shown in the table below. The stated numbers are averages of 8 measurements.

TABLE 7

| | Foliar uptake | Foliar uptake |
|---|---|---|
| Spray liquor | Tembotrione | Tembotrione |
| (RME + AMS in g/l) | (in % after 5 h) | (in % after 24 h) |
| A (1 + 0) | 0.5 | 0.5 |
| B (0 + 1) | 0.5 | 2 |
| C (1 + 1) | 4 | 12 |
| D (0.59 + 0.25) | 2 | 8 |
| E (1.18 + 0.5) | 9 | 27 |
| F (1.77 + 0.75) | 25 | 60 |

1. Oil-based adjuvant composition comprising
a) at least one oil selected from the group consisting of
1) vegetable oil
2) mineral oil
3) paraffin oil
4) fatty acid esters and mixtures of various fatty acid esters
b) suspended therein at least one ammonium salt of the formula (I) 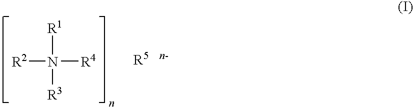
in which
R¹, R², R³ and R⁴ independently of one another represent hydrogen or in each case optionally substituted C₁-C₈-alkyl or mono- or polyunsaturated, optionally substituted C₁-C₈-alkylene, where the substituents may be selected from the group consisting of halogen, nitro and cyano,
n represents 1, 2, 3 or 4,
R⁵ represents bicarbonate, tetraborate, fluoride, bromide, iodide, chloride, monohydrogenphosphate, dihydrogenphosphate, hydrogensulphate, tartrate, sulphate, nitrate, thiosulphate, thiocyanate, formate, lactate, acetate, propionate, butyrate, pentanoate, citrate, oxalate, carbonate, pentaborate, sulphite, benzoate, hydrogenoxalate, hydrogencitrate, methylsulphate or tetrafluoroborate,
c) at least one emulsifier
d) at least one nonionic surfactant and at least one anionic surfactant
e) optionally a penetrant and
f) optionally one or more additives from the groups of the antifoams, the preservatives, the antioxidants, the spreading compositions, the colorants and the thickeners.

2. Use of a composition according to claim 1 for improving the activity of crop protection compositions.
